(19) United States
(12) Patent Application Publication
(10) Pub. No.: US 2016/0098798 A1
(43) Pub. Date: Apr. 7, 2016

(54) METHOD OF CREATING A NET LEASE USING A RISK SHIFTING METHOD FOR INVESTMENTS IN WIND POWER GENERATION

(71) Applicant: Jupiter Renewables, LLC, Armonk, NY (US)

(72) Inventor: David E. FREUND, Armonk, NY (US)

(21) Appl. No.: 14/871,314

(22) Filed: Sep. 30, 2015

Related U.S. Application Data
(60) Provisional application No. 62/058,380, filed on Oct. 1, 2014.

(51) Int. Cl. G06Q 40/06; G06Q 40/08

(52) U.S. Cl. CPC G06Q 40/06; G06Q 40/08

(57) ABSTRACT

A method for constructing a financial mechanism in a wind power generation project investment by shifting at least a portion of the risk of the wind power generation project investment from an investor to a guarantor in a manner that allows the investor to consider the investment to be a net lease is disclosed. The method includes paying a premium amount for a wind power generation project obtaining a guaranteed total return floor amount for the wind power generation project, obtaining an amount of a fixed payment associated with the wind power generation project and an amount of a variable payment associated with the wind power generation project, obtaining a wind insurance policy, an equipment insurance policy, residual value insurance and/or a Put Option with appropriate collateral, and obtaining a service provider and an asset manager for the wind power generation project in a manner that preserves the investors position as the owner/operator.

### CROSS REFERENCE TO RELATED APPLICATIONS

This application claims the benefit of priority to U.S. Provisional Patent Application No. 62/058,680, filed Oct. 1, 2014, the entire contents of which is incorporated herein by reference in its entirety, as though fully set forth herein.

### TECHNICAL FIELD

This disclosure relates generally to systems and methods that provide mechanisms for renewable energy power generation investors to shift their risk in an investment to another entity while qualifying for production tax credits under the United States tax code. More particularly, this disclosure relates to systems and method that provide mechanisms for an investor in a wind power generation project to shift the risk in the investment to a guarantor, while maintaining the role of owner and operator of the wind power generation project, and meeting the criteria to be considered a net lease.

### BACKGROUND

Generally, there are two primary types of investments: debt investments and equity investments. Debt investments are beneficial for at least two reasons. First, debt investments have a lower use of Economic Capital as defined by the International regulatory framework for banks for regulatory capital purposes. Second, financial institutions typically have a larger pool of capital available for debt investments. Equity investments are beneficial because they typically have a higher rate of return than debt investments. However, equity investments are viewed as a higher risk than debt investments, because equity capital is the first to be lost, and the rate of return is based on the economic performance of the investment. Therefore, equity investments are typically made based on the investor's ability to calculate and/or bear the risk of the investment. Because of the risks associated with equity investments, entities typically do not invest in projects in which they lack familiarity and/or the ability to adequately evaluate the risk.

Problems exist in certain complex industries where equity investments are needed but hard to obtain due to the limited ability of investors to evaluate their risks. An example of one of these complex industries is renewable energy power generation, including, but not limited to, wind power generation. Despite the complexities of this industry, systems and methods have been developed in order to mitigate the risks these investments and encourage equity investments in renewable power generation. Examples of these systems and methods may be found in U.S. Pat. No. 7,853,461 (“the '461 patent”), the contents of which are incorporated herein by reference in their entirety, which discloses systems and methods for shifting at least a portion of an investment in a wind power generation project from an investor to a guarantor. The '461 patent method creates an investment in wind power generation that has debt like features, but is not characterized as debt by regulators and accountants.

Nevertheless, even if the risk is shifted in an investment, many entities are deterred from investing in renewable energy generation projects, because of the difficulty of simultaneously qualifying for tax credits as an owner and operator of the investment while also qualifying as a debt investment for regulatory and accounting purposes. With respect to tax credits, United States tax code 26 U.S.C. §45 (“Section 45”) provides that investors can receive a production tax credit (“PTC”) for electricity produced by renewable resources, including wind. However, the PTC is only available to those investors who are both the owner and the operator of the power generation facility which is typically considered an equity investment. Moreover, with respect to regulatory and accounting purposes, it is beneficial for investments to be viewed as debt investments for reasons, which include the lesser risk of the investment and tax deductions, among other things. While the risk shifting method of the '461 makes it easier for an equity investment in a wind power generation project, it does not set forth a mechanism for the investment to be viewed as a debt investment, such as a net lease or inverted lease that is beneficial for regulatory and/or accounting purposes.

Advantages exist for equity investments in wind power generation projects to be viewed as net leases. For example, the Office of the Comptroller of the Currency considers an investment using the risk shifting method of the '461 to be a debt like investment. However, banks “must limit the total dollar amount of this and similar financing transactions for renewable energy projects to no more than three percent of its capital and surplus.”¹ On the other hand, if the wind power generation investment meets the criteria to be considered a net lease, the banks do not have a limit on making these investments. Corporate investors will often employ similar self-regulated criteria for their investments. ¹ OCC Interpretive Letter 1139

The advantages of viewing an equity investment in a wind power generation project as a net lease, or other similar debt investment, are apparent. However, until now, methods have not yet been identified for achieving this goal. This is because according to the National Renewable Energy Laboratory the owner/operator requirement for receiving the PTC sets forth that with the exception of open- and closed-loop biomass projects, the project owner must also operate the project in order to claim the PTC. This requirement effectively attempts to rule out the option of lease financing for wind power generation projects, since in a typical leasing arrangement, the owner and operator are separate entities.² The market for leases is much larger than the market for equity-like investments in wind energy. In 2012, the lease market generated $225 billion in new equipment leases. That same year, the wind power market raised $5.5 billion in tax equity investments and none of these were financed as leases. It is generally accepted by experts in the field that there is a shortage of available tax equity investment, a situation that may be remedied if there were a way to access the lease market which is 40 times larger. ² NREL/TP-6A2-45359 http://www.nrel.gov/docs/fy09osti/45359.pdf

Accordingly, there is a need for a method of transforming equity investments in renewable energy power generation, such as wind power generation, into a financial arrangement that shifts the risk in the investment in a manner that allows the investor to consider the investment to be a net lease, while maintaining the investor as the owner and operator of the investment, thereby qualifying the investor for PTC under Section 45 of the tax code. Particularly, there is a need for a method that uses the methods of the '461 patent as a building block and in a new way, such that an equity investment in a wind power generation project can be viewed as a net lease, which creates a highly credit worthy lessee in the form of a guarantor, providing a high investment grade credit profile, which is an important train for a net lease.

### SUMMARY

In general, in one aspect, the invention features a method for constructing a financial mechanism in a wind power generation project investment by shifting at least a portion of the risk of the wind power generation project investment from an investor to a guarantor in a manner that allows the investor to consider the investment to be a net lease. The method includes paying a premium amount for a wind power generation project based on Tier I energy rates, Tier II energy rates, operating expenses of the wind power generation project, and the tax benefits associated purchasing the wind power generation project, obtaining a guaranteed total return floor amount for the wind power generation project, wherein the guaranteed total return floor amount is based on stress tests on the wind power generation project, wherein the stress tests include determining the efficacy of wind insurance, equipment insurance, residual value insurance, and/or a Put Option with appropriate collateral, obtaining an amount of a fixed payment associated with the wind power generation project and an amount of a variable payment associated with the wind power generation project, wherein the fixed payment is Tier I power sales energy revenue less scheduled operating expenses of the wind power generation project, and wherein the variable payment is Tier II power sales energy revenue, obtaining a wind insurance policy, an equipment insurance policy, residual value insurance, and/or a Put Option with appropriate collateral, obtaining at least one service provider for the wind power generation project, and obtaining an asset manager for the wind power generation project in a manner that preserves the investors position as the owner/operator.

Implementations of the invention may include one or more of the following features. The method may include entering into operating leverage based on the fixed payment. The method may include entering into production tax credit debt based on capital contributions equal to a fixed percentage of an insured production tax credit value. The financial mechanism may be a service contract, a net lease, or an inverted lease. The financial mechanism may simultaneously be a service contract and a net lease. The method may include qualifying to receive a production tax credit for the wind power generation project.

In general, in another aspect, the invention features a method for creating a net lease in a wind power generation project investment by shifting at least a portion of the risk of the wind power generation project investment from an investor to a guarantor. The method includes purchasing a wind power generation project for a pre-determined premium amount, wherein the pre-determined premium amount is based on Tier I energy rates, Tier II energy rates, operating expenses of the wind power generation project, and the tax benefits associated purchasing the wind power generation project, leasing the wind power generation project to the guarantor, wherein leasing the wind power generation project includes receiving a fixed rent amount based on Tier I power sales energy revenue, receiving a variable rent Tier II power sales energy revenue, and receiving residual value insurance or a Put Option with appropriate collateral, obtaining at least one service provider for the wind power generation project, and obtaining an asset manager for the wind power generation project in a manner that preserves the investors position as the owner/operator of the wind power generation project.

Implementations of the method may include one or more of the following features. The method may include receiving a guaranteed total return floor amount, wherein the guaranteed total return floor amount is based on stress tests on the wind power generation project, wherein one factor of the stress tests includes plant availability for the wind power generation project based on forecasts for wind speed at a plant site. The method fixed rent amount may be Tier I power sales energy revenue less substantially all of operating expenses of the wind power generation project. The operating expensed of the wind power generation project may include wind insurance and equipment insurance. The method may include entering into operating leverage.

### BRIEF DESCRIPTION OF THE DRAWINGS

These and other features will be more clearly understood from the following detailed description taken in conjunction with the accompanying drawings and claims, wherein like reference numerals represent like parts.

FIG. 1 shows a flow chart of a risk shifting method, according to an exemplary embodiment;

FIG. 2 shows a flow chat of a method of transforming an equity investor in a wind power generation project into the owner and operator of the wind power generation project using the risk shifting method of FIG. 1;

FIG. 3 shows a power sales agreement, according to an exemplary embodiment;

FIG. 4 illustrates a diagram of the method of FIG. 2 viewed as a power sales and service contract, according to an exemplary embodiment;

FIG. 5 illustrates a diagram of the method of FIG. 2 viewed as a net lease agreement, according to an exemplary embodiment; and

FIG. 6 illustrates a diagram of the method of FIG. 2 viewed as an inverted lease agreement, according to an exemplary embodiment.

### DETAILED DESCRIPTION

The disclosed systems and methods provide mechanisms for renewable energy power generation investors to shift their risk in an investment to another entity while qualifying for production tax credits (“PTC”) under the United States tax code in a manner that allows the investor to consider the investment to be a net lease. More particularly, the disclosed systems and methods provide mechanisms for renewable energy power generation investors to shift their risk in renewable energy power generation projects to a guarantor, while maintaining the role of owner and operator of the renewable energy power generation project, such that the investors may qualify for PTC under the United States tax code and also qualify for benefits associated with net lease financing. It should be noted that embodiments of the present disclosure should not be limited to net lease financing, but rather are applicable to any form of lease financing. Additionally, the renewable energy power generation investments may be any power generation projects produced by renewable resources, including, but not limited to wind.

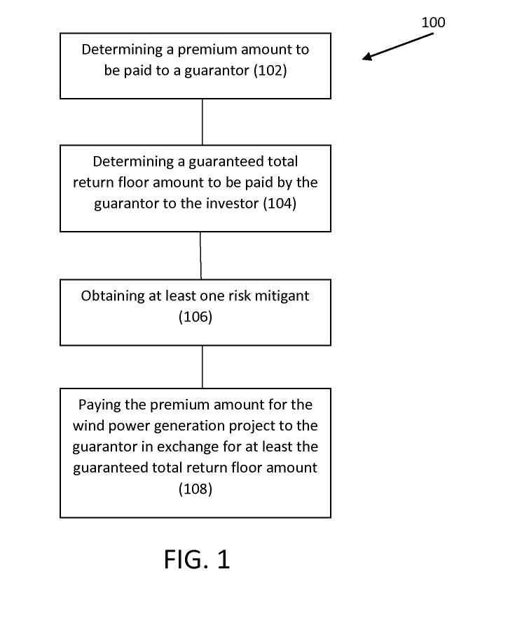

Embodiments of the present disclosure incorporate the risk shifting systems and methods disclosed in U.S. Pat. No. 7,853,461 (“the '461 patent”), the contents of which are incorporated herein by reference in their entirety. As previously discussed in the Background of the present disclosure, systems and methods have been developed in order to mitigate the risks of and encourage equity investments in wind power generation projects. For example, the flow chart of FIG. 1 shows a method 100 for shifting at least a portion of the risk associated with a wind power generation project investment from an investor to a guarantor. The method 100 may include determining a premium amount to be paid to a guarantor 102. The guarantor may be any individual and/or entity or structured entity who possesses the ability and/or knowledge to assess risks associated with investments in wind power generation projects.

The risk shifting method 100 may further include determining a guaranteed total return floor amount to be paid by the guarantor to the investor 104. In some embodiments, the guaranteed total return floor may first be calculated based on anticipated assets of the wind power generation project, including but not limited to tax credits, pre-tax cash flow, post-tax cash flow, dividends, or combinations thereof. After calculating the guaranteed total return floor amount, the sufficiency of the amount may be quantitatively and/or statistically determined based on stress tests on the wind generation project, as detailed herein. For example, in some embodiments, the stress tests may be based on wind power generation project assumptions and/or factors such as plant availability based on forecasts for wind speed at the plant site. In some embodiments, the guaranteed total return floor amount may be configured to be paid by the guarantor to the investor in the form of a single payment at an agreed upon time. Alternatively, in some embodiments, the guaranteed total return floor amount may be configured to be paid by the guarantor to the investor periodically for an agreed upon term. In other embodiments the guaranteed floor will be a de facto guarantee based on the implementation of the risk mitigation.

FIG. 1 shows that the risk shifting method 100 may further include obtaining at least one risk mitigant 106. The at least one risk mitigant may be obtained by the investor and/or the guarantor and may include any financial and/or structural support that may be configured to mitigate the guarantor's risk in the wind power generation project. In some embodiments, for example, the at least one risk mitigant may include, but is not limited to, wind insurance, wind power generation equipment insurance, residual value insurance, a put option with appropriate collateral, and/or combinations thereof. The risk shifting method 100 may be configured such that the investor may pay the guarantor the pre-determined premium amount for the wind power generation project in exchange for at least the guaranteed total return floor amount 108. In some embodiments, payment of the pre-determined premium amount to the guarantor may be conditioned upon the guarantor obtaining the at least one risk mitigant.

The risk shifting method 100 may be structured such that the investor in the wind power generation project may receive PTC under the United States tax code. Particularly, 26 U.S.C. §45 sets forth that PTC may be received for electricity produced by renewable resources, including wind, and sold to an unrelated person. Section 45 further sets forth that in order for a taxpayer to receive the PTC, the taxpayer must be both the owner and the operator of the wind power generation project. Accordingly, in some embodiments, the steps associated with the risk shifting method 100 may be structured within a method such that the investor in the wind power generation project may be viewed as both the owner and the operator of the wind power generation project in a manner that allows the investor to consider the investment to be a net lease.

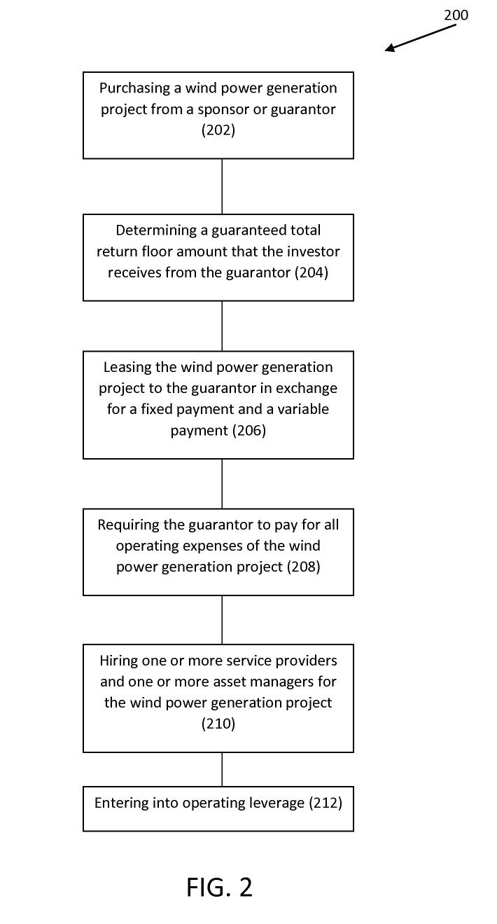

FIG. 2 shows a flow chart of a method 200 of creating a mechanism that allows an equity investor in a wind power generation project to qualify for the PTC, using the risk shifting method of FIG. 1 in a manner that allows the investment to be viewed as a net lease, according to an exemplary embodiment. The method 200 may first include purchasing a wind power generation project from a sponsor or a guarantor 202 for a pre-determined premium amount. For example, in some embodiments, the sponsor or the guarantor may construct the wind power generation project and sell it to the investor for the premium amount, which may be paid up front or as an ongoing premium. Alternatively, in some embodiments, the premium may be embedded in other fees received by the guarantor. The sales proceeds from the purchasing the wind power generation project may consist of any payment mechanism known to those skilled in the art, including, but not limited to, cash and/or a note payable.

The premium amount may be a pre-determined monetary value that the investor and/or guarantor calculates the wind power generation investment to be worth. The premium amount may be determined based any desired factors that may be associated with the wind power generation project, including, but not limited to, Tier I and Tier II energy rates, operating expenses of the wind power generation project, and tax benefits that may be associated with investments in the wind power generation project. In some embodiments, the premium amount may be calculated and/or defined as the investment is worth using the risk shifting method 100 of FIG. 1 and the method 200 disclosed herein that converts the investment into a net lease less the amount the investment would be worth without the risk shifting method 100 of FIG. 1 and the method 200 disclosed herein that converts the investment into a net lease. Alternatively, or in addition, in some embodiments, the premium amount may be determined based on the weighted average cost of capital (“WACC”) for the wind power generation investment. For example, the WACC for a wind power generation investment using the risk shifting method 100 of FIG. 1 and the method 200 of converting the investment into a net lease of FIG. 2 will be materially lower than the WACC for a wind power generation investment that does not use the methods 100, 200 of FIGS. 1 and 2 due to the lowering of risk and the increasing liquidity of the investment that can now be sold as a net lease. More particularly, in some embodiments, the WACC for a wind power generation investment without the methods of FIGS. 1 and 2 may be in the 8.5% to 10.5% range, whereas the WACC may be lowered to a 5% Guaranteed Floor range with an expectation of a 6.5%. return using the methods 100, 200 of FIGS. 1 and 2, which may be more marketable to investors.

The method 200 may further include determining a guaranteed total return floor amount 204 that the investor may receive from the guarantor. The guaranteed total return floor amount may be calculated based on obligations and/or support guaranteed by the guarantor. In some embodiments, for example, the guaranteed total return floor amount may be based on the risk shifting method 100 of FIG. 1. For example, the guaranteed total return floor amount may be equal to the return that the investor will receive based on the insured level of wind revenue.

In addition, or alternatively, the guaranteed total return floor amount may be quantitatively and/or statistically determined based on stress tests on the wind generation project. In some embodiments, the stress tests may be based on wind power generation project assumptions and/or factors such as plant availability based on forecasts for wind speed at the plant site. For example, an initial round of stress tests may determine whether wind insurance is efficacious using tools that may include, but are not limited to, Monte Carlo simulation to determine if, based on the available wind data, the insurance coverage would have been successful in the past. If the wind insurance is deemed effective, another round of stress tests may be performed to determine the efficacy of wind power generation project equipment insurance coverage or the Original Equipment Manufacture's equivalent coverage. If the equipment insurance is determined to be effective, a further stress test may be performed to determine the efficacy of residual value insurance or a Put Option with appropriate collateral or an equivalent mechanism. If the effectiveness of all of the mechanisms is proven, then the stress test and the guaranteed total return floor calculation may use the same modeled case.

The guaranteed total return floor amount may be paid to the investor periodically in a manner disclosed herein. For example, in some embodiments, the investor may construct a financial mechanism that may be viewed and/or documented in a manner such that the investor may simultaneously shift at least a portion of the risk of investment in the wind power generation project to the guarantor and maintain the role of both owner and operator of the wind power generation project. In some embodiments, for example, the investor may construct a financial mechanism that may be viewed and/or documented as a service contract for tax purposes and as a net lease or inverted lease for accounting and/or regulatory purposes.

For example, the method 200 of FIG. 2 shows that constructing a financial mechanism may include leasing the wind power generation project to a guarantor in exchange for a fixed payment and a variable payment from the guarantor 206. In some embodiments, the fixed payment and the variable payment may be based on wind power generation project cash-flows which include, but are not limited to, Tier I power sales energy revenue, Tier II power sales energy revenue, and project operating expenses. In one embodiment, the fixed payment may be determined based on the Tier I power sales energy revenue less the project operating expenses, and the variable payment may be determined based on the Tier II power sales energy revenue. Additionally, in some embodiments, the investor may choose to receive the fixed payment on an unleveraged basis without borrowing, such that the fixed payment may include hypothetical amounts for principal and interest payments as if the fixed payment had leverage.

More particularly, in some embodiments, the fixed payment may be based on Tier I energy sales revenue and may be structured to be equivalent to a payment that a lessee would make on a lease of a proposed asset. For example, in some embodiments the fixed payment may be equal the revenue received for all Tier I energy less all operating costs of the wind power generation project, including, but not limited to property tax and insurance. In exemplary embodiments, the fixed payment may be equal the price that the guarantor sells the power it receives from the investor under a sales contract such as a Power Purchase Agreement or a Commodities Energy Hedge. The amount of the fixed payment may be capped at a certain value. For example, in some embodiments, the fixed payment may be no higher than the insured amount of energy production under the wind insurance. It is noted that in some embodiments, the fixed payment does not have to be a “hell or high water” payment, as the guarantor/lessee and the payment may be supported by the methods of the '461 patent.

The fixed payment may also be an amount that may be sufficient to support debt, whether real, hypothetical or in the form of a pre-payment from a Municipal Power Purchaser, that the investor may want to undertake with regards to the wind power generation project. In some embodiments, hypothetical debt principal and/or interest payments may be equal to the principal and interest payments that the investor may be configured to support, if the investor so chooses, from the cash flow from the investment. The lessee has latitude to set the fixed payment by setting the amount of energy covered under Tier I so long as the amount of energy is sufficient to support payment of all operating expenses by the guarantor.

The variable payment may be based upon Tier II energy sales revenue and may be for any power sales in excess of the amount subject to the fixed payment. The variable payment may be set at an agreed rate that provides the investor with an acceptable pre-tax and after-tax profit from the transaction. In some embodiments, the guarantor may have a sales contract to support its sales of power received under Tier II. Alternatively, in some embodiments, the Tier II rate may be set at a level that may be low enough such that the investor may not be exposed to commodity price risk.

Constructing the financial mechanism may also include the guarantor making all payments for operating expenses of the wind power generation project and/or obtaining residual value insurance or a Put Option with appropriate collateral, which may take the functional form of insurance for the form of a Put Option with appropriate collateral 208. In some embodiments, the operating expenses may include at least one risk mitigating feature, such as wind insurance, equipment insurance, a manufacturer's warranty or Full Service Agreement for an equivalent time period from a credit worth provider, availability guarantees, and/or a full service operations and maintenance agreement that may cover substantially all scheduled and unscheduled equipment maintenance items. In some embodiments, the operating expenses may further include the guarantor nominating at least one wind power generation project plant operator and/or providing acceptable criteria for the investor to hire at least one wind power generation project plant operator. Additionally, in some embodiments, the operating expenses may include providing the investor with a two-tier power sales agreement that has sufficient credit quality either through entering into an acceptable power purchase agreement or commodity price hedge, or providing adequate credit support.

FIG. 2 further illustrates that the method 200 may include the step of obtaining one or more service providers and/or one or more asset managers for the wind power generation project 210. In some embodiments, the one or more service providers and/or the one or more asset managers may be obtained based on the nominations and/or criteria provided by the guarantor. The criteria may include any criteria that may aid an investor in determining whether to hire a particular service provider and/or an asset manager and may establish a level of control by the guarantor that may be considered a characteristic of a net lease. For example, the criteria may include a stipulation that the investor enter into one or more contracts corresponding to the risk shifting method 100 of FIG. 1, for which the guarantor will pay Tier I revenue. Additionally, or alternatively, the criteria may include the service provider and/or asset manager exhibit standards of operation that may be at a higher level than required under Prudent Utility Practice.

The investor may have the authority to hire and/or fire each of the service providers. Additionally, the investor may be authorized to take reasonable and appropriate action to protect the value of the wind power generation project or its interests under the financial mechanism if there is a change in condition, such as a change that may threaten the investor's financial position by increasing its exposure to loss. The investor may also have the authority to hire and/or fire the one or more asset managers. The one or more asset managers may be configured such that the investor and the guarantor may delegate decision-making authority thereto with the exception of decisions deemed to be necessary due to a change in condition. The delegation of decision-making authority to the one or more asset managers may be possible, because risk shifting may be configured to reinforce stability of the wind power generation project.

In some embodiments, the method 200 may also include a step of entering into leverage 212. Entering into leverage 212 may include operating leverage based on the fixed payment. In some embodiments, the operating leverage or pre-payment from the power purchaser may be entered into using the investors operating cash flows under Tier I. For example, the principal and interest payments may be calculated using industry standard conventions. However, the debt service coverage ratio may be set at a lower level than standard to reflect the lower level of risk. Alternatively, or in addition, entering into leverage 212 may include PTC debt based on capital contributions equal to a fixed percentage of the insured value for the PTC's. For example, in some embodiments, the investors may agree to contribute up to $1 for every $1 of PTC that they receive. This capital contribution may then become the cash flow available for debt service. Because of the presence of insurance, the debt service coverage ratio may be set at a lower level than standard to reflect a lower level of risk in the wind power generation investment.

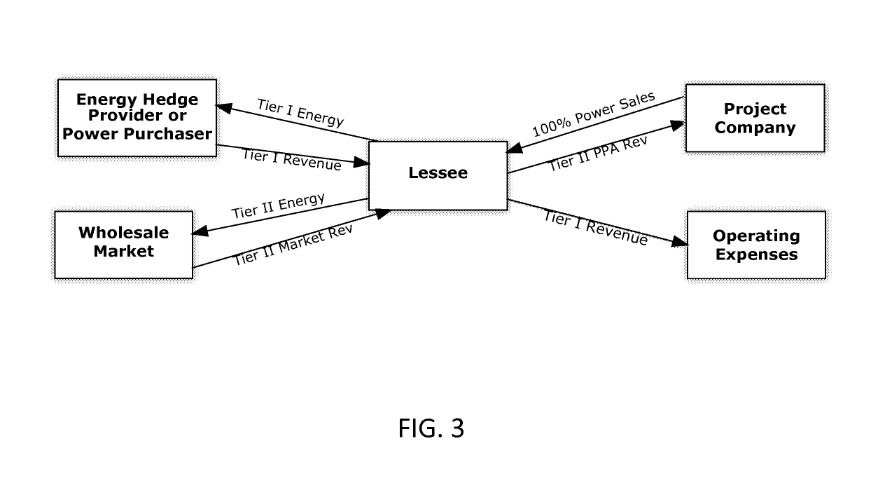

FIGS. 3-6 illustrate various diagrams showing how the method 200 of FIG. 2 may be viewed and/or documented for tax, regulatory, and/or accounting purposes. For example, as previously discussed, the method 200 may include constructing a financial mechanism such that the investor receives a fixed payment and a variable payment from the guarantor 208 and further that the fixed payment and variable payment may be based on Tier I and Tier II energy revenues. In some embodiments, and as illustrated in FIG. 3, the financial mechanism include a power sales agreement between the investor and the guarantor.

In the embodiment FIG. 3, the lessee may be the guarantor, and the project company may be the owner/investor of the wind power generation project. The power sales agreement of FIG. 3 may be structured to cover 100% of energy sales from the wind power generation project. Alternatively, in other embodiments, the power sales agreement may be structured to cover any percentage of energy sales as desired by the investor and/or the guarantor. As illustrated in FIG. 3, the Tier I power sales may be configured to cover the operating expenses of the wind power generation project and the actual or hypothetical principal and interest payments. The cash flow available for debt service may be established using an amount of Tier I energy sales revenue that is less than or equal to the insured level of Tier I energy sales revenue less the maximum operating expenses for the wind power generation project, assuming the insurance. This resulting amount may be used to amortize the debt by creating a principal and interest schedule. In some embodiments, such as the embodiment of FIG. 3, the Tier I power sales may be backed by adequate credit support from the guarantor and/or guarantor's affiliate and/or may be backed by an acceptable energy hedge or power purchase agreement (“PPA”).

FIG. 3 illustrates that the power sales agreement may be structured such that the investor may receive at last a portion of the Tier II power energy sales revenues. Additionally, FIG. 3 illustrates that in some embodiments, the Tier II power energy sales revenue may not be backed by credit support; however, the Tier II revenue must be at a level that may be low enough for the investor to perceive that he/she is not taking an unacceptably high commodity risk. For example, in some embodiments, the level that may be low enough for the investor to perceive that he/she is not taking an unacceptably high commodity risk may be from a low case, i.e., P90, projection of energy rates for the wind power generation project.

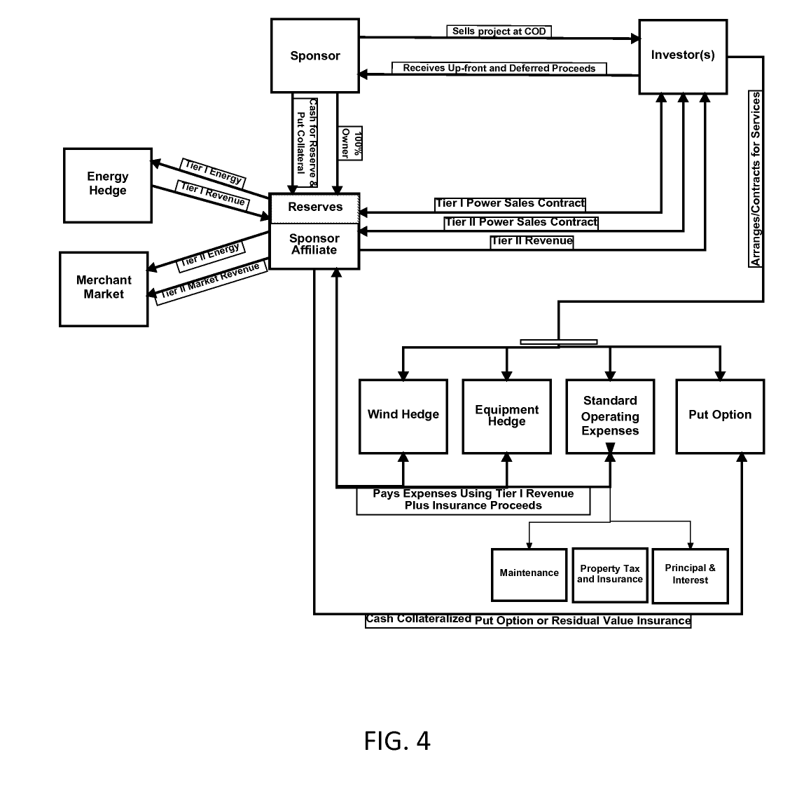

FIG. 4 illustrates a diagram showing the method 200 of FIG. 2 being viewed as a power sales and service contract, according to an exemplary embodiment. In the embodiment of FIG. 4, the sponsor affiliate may be the guarantor, and the credit behind the guarantee may be based on the strength of the guarantee package that risk shifting may provide. For example, in some embodiments, the credit behind the guarantee may be based on a guarantee package that includes wind insurance, equipment insurance, residual value insurance, and/or a put option that may be backed by acceptable collateral. Additionally, in the embodiment of FIG. 4, the sponsor affiliate (i.e., the guarantor) may choose to provide the investor with an explicit guaranteed of a guaranteed total return floor amount. Alternatively, the sponsor affiliate may choose to package different element of risk mitigation to provide an implicit synthetic floor.

As previously discussed, in some embodiments, the investor may construct a financial mechanism that may be viewed as a service contract for tax purposes. Particularly, the service contract may be advantageous because it a financial mechanism allows the investor to qualify for the PTC under the United States tax code. FIG. 4 illustrates that when the method 200 is viewed as a service contract, the investor may be the owner and operator of the wind power generation project based on the investor's role with respect to the Tier I and Tier II power energy sales contract with the guarantor and based on the investors role in arranging contracts for services for the wind power generation project.

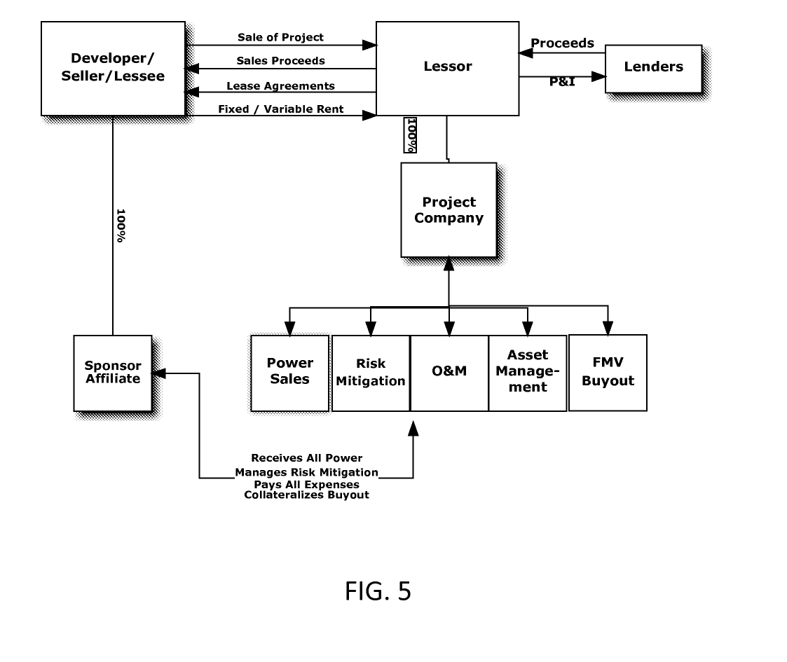

FIG. 5 shows a diagram of how the method of FIG. 2 may also be viewed as a net lease for regulatory and/or accounting purposes. In the embodiment of FIG. 5, the lessor may be the investor and the developer/seller/lessee may be the guarantor. As illustrated in FIG. 5, the financial mechanism disclosed in the method 200 of FIG. 2 may be structured such that after the investor purchases the wind power generation project, the investor may lease the wind power generation project to the guarantor in exchange for the fixed and variable payments, i.e., rent, and in exchange for obtaining at least one risk mitigating feature, including, but not limited to insurance. In some embodiments, the investor may lease the wind power generation project in a manner that ensures that the investor may earn satisfactory pre-tax yields, i.e. to satisfy the economic substance requirement and after-tax yields, i.e., to provide the investor an adequate return on its funding cost based on the risk of the investment.

Additionally, similar to the embodiment of FIG. 4, the investor may be proved with a guaranteed total return floor amount explicitly from the guarantor, or alternatively may be provided with an implicit guarantee from the guarantor to produce a guaranteed total return floor amount. As previously discussed, the sufficiency of the guaranteed total return floor amount may be quantitatively and statistically determined based on stress tests on the wind power generation project. FIG. 5 further illustrates that the method of FIG. 5 may be viewed as a net lease, because the structure of the method 200 satisfies the criteria for classification as a net lease identified by the Office of the Comptroller of the Currency (“OCC”). The OCC definition sets forth that under a net lease, the lessor will not provide or be obligated to provide servicing, repair, or maintenance during the lease term, parts or accessories for the leased property, loan replacement or substitute property while the leased property is being service, payment of insurance for the lease, and renewal of any license or registration for the property unless renewal by the lessor is necessary to protect the interest as the owner or financier of the property.

The structure of the method 200 may also satisfy the criteria for classification as a net lease according to generally accepted accounting principles, which may treat the method 200 of FIG. 2 as a lease financing. According to the Financial Accounting Standards Board's Accounting Standards Codification 840 (“ASC 840”), a reporting entity assesses whether an arrangement contains a lease based on its substance, which depends on an identified power plant and conveys to the purchaser, i.e., the lessee/guarantor, the right to control the use of the power plant. More particularly, according to ASC 840, if any of a number of specified conditions are met and there is specific property, plant, and equipment, then the arrangement is a lease. The specified conditions include: (1) the purchaser has the ability or right to operate the property, plant, or equipment or direct others to operate the property, plant, or equipment in a manner it determines while obtaining or controlling more than a minor amount of the output or other utility of the property, plant, or equipment. The purchaser's ability to operate the property, plant, or equipment may be evidenced by (but is not limited to) the purchaser's ability to hire, fire, or replace the property's operator or the purchaser's ability to specify significant operating policies and procedures in the arrangement with the owner-seller having no ability to change such policies and procedures; (2) the purchaser has the ability or right to control physical access to the underlying property, plant, or equipment while obtaining or controlling more than a minor amount of the output or other utility of the property, plant, or equipment; and (3) facts and circumstances indicate that it is remote that one or more parties other than the purchaser will take more than a minor amount of the output or other utility that will be produced or generated by the property, plant, or equipment during the term of the arrangement, and the price that the purchaser (lessee) will pay for the output is neither contractually fixed per unit of output nor equal to the current market price per unit of output as of the time of delivery of the output.

FIG. 5 and the method of FIG. 2 illustrate that the above regulatory and accounting definitions may be satisfied as a result of risk shifting from the investor to the guarantor. For example, in the embodiment of FIG. 5, and as previously discussed with respect to the method 200 of FIG. 2, the guarantor, rather than the investor may be responsible for setting criteria that cannot be changed for and paying for wind insurance, wind power generation project equipment insurance, residual value insurance and/or a Put Option with appropriate collateral. Additionally, the guarantor, rather than the investor, may be responsible for payment of the wind power generation project's operating expenses.

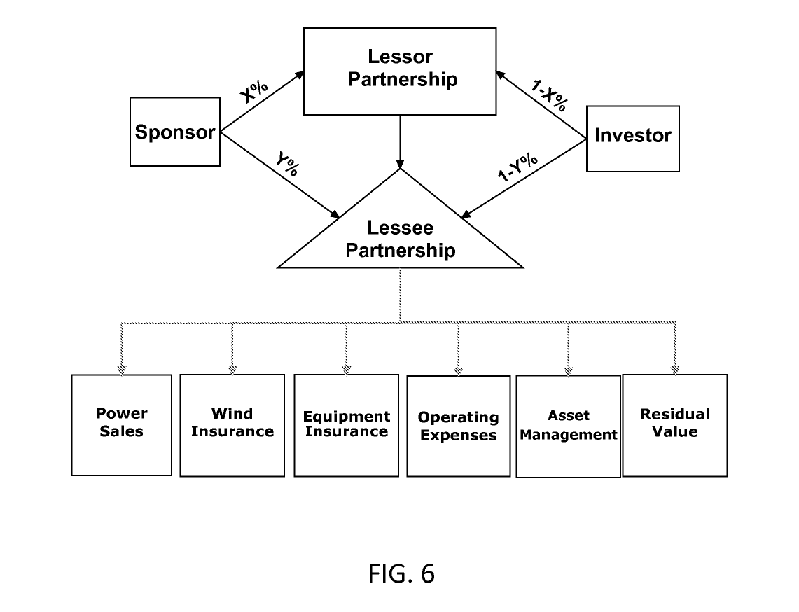

FIG. 6 illustrates a diagram of how the method 200 of FIG. 2 may be structured, according to an exemplary embodiment. As illustrated in FIG. 6, both this investor and the sponsor/guarantor may have a share as the lessor and as the lessee. For example, in some embodiments, the lessor may be majority owned by the sponsor/guarantor and the investor may be the majority owner of the lessee. The investor may be viewed as a master tenant, and the guarantor may elect to pass-through the PTC to the investor. In order for the investor to be viewed as the owner and operator of the wind power generation project, risk in the investment may be shifted from the investor to the sponsor/guarantor.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be made to the accompanying drawings and descriptive matter.

What is claimed:

1. A method for constructing a financial mechanism in a wind power generation project investment by shifting at least a portion of the risk of the wind power generation project investment from an investor to a guarantor in a manner that allows the investor to consider the investment to be a net lease, comprising:
paying a premium amount for a wind power generation project based on Tier I energy rates, Tier II energy rates, operating expenses of the wind power generation project, and the tax benefits associated purchasing the wind power generation project;
obtaining a guaranteed total return floor amount for the wind power generation project, wherein the guaranteed total return floor amount is based on stress tests on the wind power generation project, wherein the stress tests include determining the efficacy of wind insurance, equipment insurance, residual value insurance, and/or a Put Option with appropriate collateral;
obtaining an amount of a fixed payment associated with the wind power generation project and an amount of a variable payment associated with the wind power generation project, wherein the fixed payment is Tier I power sales energy revenue less scheduled operating expenses of the wind power generation project, and wherein the variable payment is Tier II power sales energy revenue;
obtaining a wind insurance policy, an equipment insurance policy, residual value insurance, and/or a Put Option with appropriate collateral;
obtaining at least one service provider for the wind power generation project; and
obtaining an asset manager for the wind power generation project in a manner that preserves the investors position as the owner/operator.

2. The method of claim 1, further comprising entering into operating leverage based on the fixed payment.

3. The method of claim 1, further comprising entering into production tax credit debt based on capital contributions equal to a fixed percentage of an insured production tax credit value.

4. The method of claim 1, wherein the financial mechanism is a service contract.

5. The method of claim 1, wherein the financial mechanism is a net lease.

6. The method of claim 1, wherein the financial mechanism is an inverted lease.

7. The method of claim 1, wherein the financial mechanism may simultaneously be a service contract and a net lease.

8. The method of claim 1, further comprising qualifying to receive a production tax credit for the wind power generation project.

9. A method for creating a net lease in a wind power generation project investment by shifting at least a portion of the risk of the wind power generation project investment from an investor to a guarantor, comprising:
purchasing a wind power generation project for a pre-determined premium amount, wherein the pre-determined premium amount is based on Tier I energy rates, Tier II energy rates, operating expenses of the wind power generation project, and the tax benefits associated purchasing the wind power generation project;
leasing the wind power generation project to the guarantor, wherein leasing the wind power generation project includes receiving a fixed rent amount based on Tier I power sales energy revenue, receiving a variable rent Tier II power sales energy revenue, and receiving residual value insurance or a Put Option with appropriate collateral;
obtaining at least one service provider for the wind power generation project; and
obtaining an asset manager for the wind power generation project in a manner that preserves the investors position as the owner/operator of the wind power generation project.

10. The method of claim 9, further comprising receiving a guaranteed total return floor amount, wherein the guaranteed total return floor amount is based on stress tests on the wind power generation project, wherein one factor of the stress tests includes plant availability for the wind power generation project based on forecasts for wind speed at a plant site.

11. The method of claim 9, wherein the fixed rent amount is Tier I power sales energy revenue less substantially all of operating expenses of the wind power generation project.

12. The method of claim 11, wherein the operating expensed of the wind power generation project includes wind insurance and equipment insurance.

13. The method of claim 9, further comprising entering into operating leverage.
